(19) United States
(12) Patent Application Publication
(10) Pub. No.: US 2020/0141241 A1
(43) Pub. Date: May 7, 2020

(54) TANGENTIAL ON-BOARD INJECTOR (TOBI) ASSEMBLY

(71) Applicant: PRATT & WHITNEY CANADA CORP., Longueuil (CA)

(72) Inventor: Ivan SIDOROVICH PARADISO, Toronto (CA)

(21) Appl. No.: 16/178,824

(22) Filed: Nov. 2, 2018

(51) Int. Cl. F01D 5/08; F01D 9/04

(52) U.S. Cl. CPC F01D 5/087; F01D 9/048; F05D 2260/232; F05D 2220/32; F05D 2240/128; F01D 9/041

(57) ABSTRACT

A TOBI assembly including a TOBI having a body adapted to be fixed to a stator assembly and defining an annular passageway to receive cooling air, and defining a plurality of discharge nozzles. A back plate configured to be mounted to a rotor assembly to rotate therewith. The back plate has an axial portion spaced radially inwardly from the plurality of discharge nozzles. The axial portion has radially-spaced outer and inner walls defining an annular flow transition chamber. The flow transition chamber has a radial segment extending radially inwardly from an inlet opening communicating with the discharge nozzles, and an axial segment extending axially from the radial segment to an outlet opening configured to deliver the cooling air to a rotor assembly.

### TECHNICAL FIELD

The application relates generally to providing cooling air to components of gas turbine engines and, more particularly, to a tangential on-board injector (TOBI) assembly.

### BACKGROUND

Blades, vanes, and other components of gas turbine engines susceptible to damage by a hot gas stream, such as turbine components, can be cooled by air compressed upstream within the engine and flowed to the turbine components. A tangential on-board injector (TOBI) is used for this purpose, where an inlet of the TOBI receives compressed air, typically emanating from the compressor, and discharges a stream of cooling air tangentially to the rotating turbine assembly.

With some TOBIs, increasing static pressure at the outlet of the TOBI is achieved by increasing both the radial and the tangential speed of the flow out of the TOBI nozzles. The increased speed may result in higher relative velocity in the rotating frame at the entrance of the turbine back plate, which may result in higher losses and pressure drop due to flow turning.

### SUMMARY

In one aspect, there is provided a tangential on-board injector (TOBI) assembly of a gas turbine engine, the TOBI assembly comprising: a TOBI having a body defining an annular passageway configured to receive cooling air, and defining a plurality of discharge nozzles; and a back plate configured to be mounted for rotation relative to the body about an axis, the back plate having an axial portion spaced radially inwardly from the plurality of discharge nozzles, the axial portion having radially-spaced outer and inner walls defining an annular flow transition chamber, the flow transition chamber having a radial segment extending radially inwardly from an inlet opening communicating with the discharge nozzles, and an axial segment extending axially from the radial segment to an outlet opening configured to deliver the cooling air to a rotor assembly.

In another aspect, there is provided a method for providing cooling air to a rotor assembly of a gas turbine engine, the method comprising: conveying the cooling air through a tangential on-board injector (TOBI) to discharge the cooling air from nozzles; conveying the cooling air discharged from the nozzles of the TOBI to a back plate rotating with the rotor assembly about an axis of rotation, including conveying the cooling air in a substantially radial direction toward the axis and into the back plate, and then conveying the cooling air in a substantially axial direction through the back plate to an outlet opening; and conveying the cooling air from the outlet opening of the back plate in a substantially radial direction to the rotor assembly.

In another aspect, there is provided a gas turbine engine, comprising: a casing assembly; a rotor assembly rotatable relative to the casing assembly about an axis of the gas turbine engine; a TOBI having a body fixed to the casing assembly and defining an annular passageway configured to receive cooling air, and defining a plurality of discharge nozzles; and a back plate mounted to the rotor assembly to rotate therewith about the axis, the back plate having an axially-extending portion spaced radially inwardly from the plurality of discharge nozzles, the axially-extending portion having an outer wall and an inner wall spaced radially inwardly from the outer wall, the axial portion defining an annular flow transition chamber between the outer and inner walls, the flow transition chamber having a radial segment extending radially inwardly from an inlet opening defined in the outer wall and communicating with the plurality of discharge nozzles, and an axial segment extending axially from the radial segment to an outlet opening spaced axially from the radial segment, the outlet opening configured to deliver the cooling air to the rotor assembly.

### BRIEF DESCRIPTION OF THE DRAWINGS

Reference is now made to the accompanying figures in which:

FIG. 1 is a schematic cross-sectional view of a gas turbine engine;

FIG. 2 is a schematic cross-sectional view of the enlarged portion II-II shown in FIG. 1, showing a tangential on-board injector (TOBI) assembly according to an embodiment of the present disclosure;

FIG. 3 is a perspective view of part of a back plate of the TOBI assembly shown in FIG. 2;

FIG. 4A shows flow patterns due to swirl through the components of a prior art TOBI; and

FIG. 4B shows flow patterns due to swirl through the components of the TOBI assembly shown in FIG. 2.

### DETAILED DESCRIPTION

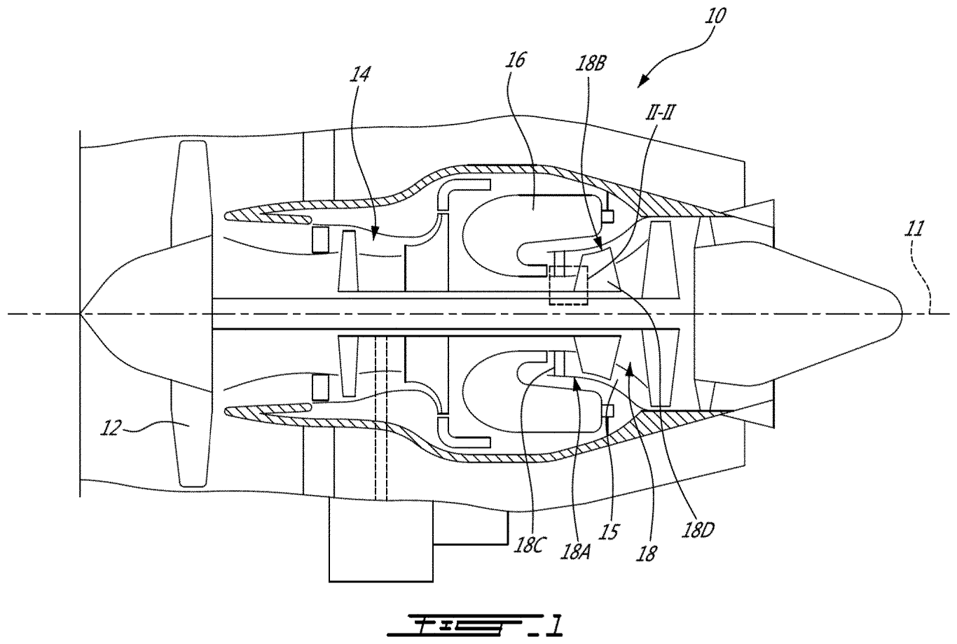

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. Components of the gas turbine engine 10 rotate about a longitudinal center axis 11.

The turbine section 18 includes a stator assembly 18A and a rotor assembly 18B. A flow path 15 for the hot combustion gases is provided downstream of the combustor 16, and extends axially between alternating rows of stator vanes 18C of the stator assembly 18A, and rotor blades 18D of the rotor assembly 18B.

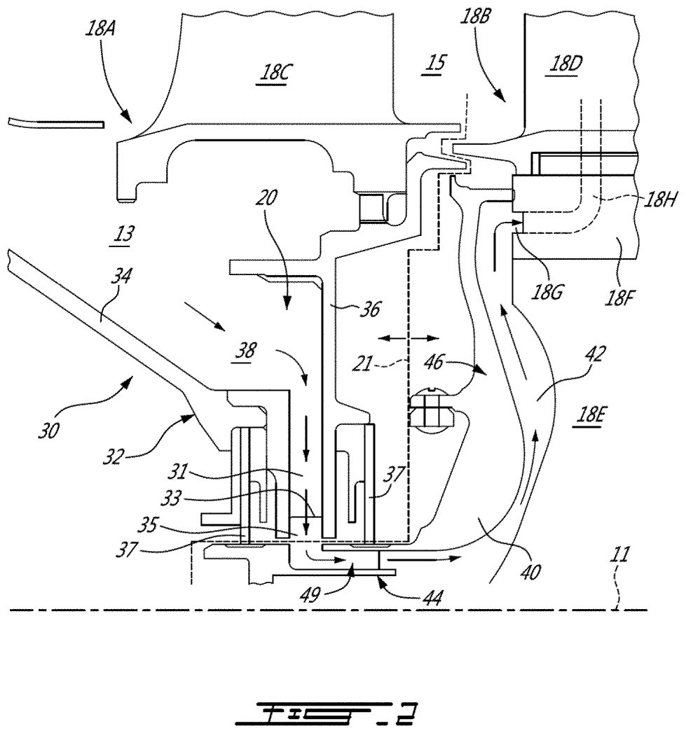

Referring to FIG. 2, an annular cavity 13 is formed within the stator assembly 18A and it functions in part as a reservoir for receiving cooling air from its source, for example, the discharge of the compressor section 14. The stator assembly 18A may be mounted to, or part of, a casing of the engine 10, and may therefore sometimes be referred to herein as a casing assembly. The cooling air is provided to the rotor assembly 18B to cool the rotor blades 18D, as described in greater detail below. In FIG. 2, immediately downstream of the row of stator vanes 18C is disposed the row of rotor blades 18D. The rotor blades 18D rotate about the center axis 11, and extend radially outwardly from a supporting rotor disk 18E via respective rotor blade roots 18F which are mounted in the supporting rotor disk 18E. The supporting rotor disk 18E includes a plurality of inlets 18G, each communicating with internal passages 18H of the rotor blade root 18F and the rotor blade 18D, through which the cooling air is flowable to cool the rotor blade 18D.

A cooling structure of the present disclosure is shown in FIG. 2 in the form of a Tangential On-Board Injection (TOBI) assembly 20. The TOBI assembly 20 helps to direct the cooling air in a direction of rotation of the rotor assembly 18B and further into the rotor assembly 18B to cool components thereof, such as the rotor blades 18D. The TOBI assembly 20 includes a TOBI 30 to increase the stagnation pressure of the cooling air, and a rotatable back plate 40 to distribute the cooling air to the rotor assembly 18B, both of which are not described.

In the embodiment shown in FIG. 2, the TOBI 30 is a stationary component. The TOBI 30 does not rotate with the rotor assembly 18B or with the back plate 40. In the depicted embodiment, the TOBI 30 is made stationary because a body 32 of the TOBI 30 is fixedly attached to the stator assembly 18A. FIG. 2 includes a demarcation line 21 which delineates the stationary or “static” components (e.g. the TOBI 30) of the TOBI assembly 20 from the rotating components (e.g. the back plate 40) of the TOBI assembly 20. In an alternate embodiment, the TOBI 30 is displaceable.

The TOBI 30 has an annular upstream wall 34 and an annular downstream wall 36, it being understood that “upstream” and “downstream” are relative positions determined with respect to the direction of flow of the cooling air. The upstream and downstream walls 34,36 define an annular passageway 38 for receiving the cooling air. A plurality of circumferentially spaced-apart passages 31, which may be oriented in a tangential angle towards the direction of rotation of the rotor assembly 18B, extend radially inwardly toward the axis 11 and terminate at nozzles 33 which are provided to inject the cooling air from the annular passageway 38 into an annular transfer chamber 35 disposed radially inwardly from the nozzles 33. The transfer chamber 35 is a plenum in which the cooling air collects before it is transferred or provided to the back plate 40. In operation, the cooling air enters the annular passageway 38 then is discharged by the nozzles 33 into the transfer chamber 35, and then to the rotating back plate 40. The nozzles 33 impart a swirl flow vector or swirling movement to the cooling air discharged into the transfer chamber 35, and also impart a radial flow vector being transverse or normal to the axis 11. The transfer chamber 35 is sealed with seals 37 which engage the rotating back plate 40 to prevent or reduce leakage of cooling air from the transfer chamber 35.

In FIG. 2, the TOBI 30 is shown as a “radial” TOBI because the cooling air enters the TOBI 30 along a radial flow path. In an alternate embodiment, the TOBI 30 is an axial TOBI where the cooling air enters the TOBI 30 along an axial flow path. In some configurations of the gas turbine engine 10, a radial TOBI may be preferred because of its smaller axial length when compared to an axial TOBI.

Still referring to FIG. 2, the back plate 40 is mounted to the rotor assembly 18B to rotate with the rotor assembly 18B about the same axis 11. Rotation of the rotor assembly 18B causes rotation of the back plate 40. The back plate 40 is a cover plate or rotor cover that is positioned axially downstream or aft of the TOBI 30. The back plate 40 has an annular shape in the depicted embodiment.

In the depicted embodiment, the back plate 40 is mounted upstream of the rotor disk 18E to rotate with it. The back plate 40 is mounted such that the radially outer periphery of the back plate 40 is forced by a centrifugal force to abut the rotor blade root 18F as the rotor assembly 18B rotates about the axis 11 so that an annular and radial passage 42 is formed between the rotor disk 18E and the back plate 40. Other embodiments for mounting the back plate 40 are possible and within the scope of the present disclosure.

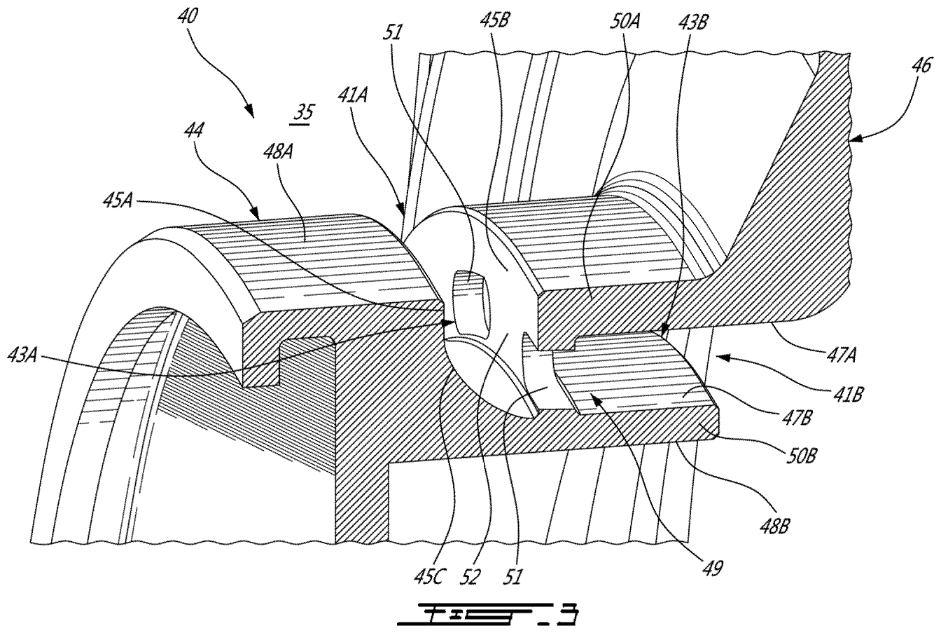

Referring to FIGS. 2 and 3, the cooling air flows into and through the back plate 40 to be supplied to the radial passage 42, and thence to the inlets 18G of the rotor disk 18E to cool the rotor blades 18D. The back plate 40 has an axial portion 44 and a radial portion 46. The axial portion 44 has an axial extent along a direction parallel to the axis 11, and the radial portion 46 has a radial axial extent along a direction transverse to the axis 11. The axial portion 44 is axially forward or upstream of the radial portion 46. The axial portion 44 is spaced radially inwardly (i.e. towards the axis 11) of the nozzles 33 of the TOBI 30, and receives the cooling air from the nozzles 33.

The axial portion 44 has an annular radially-outer wall 48A and an annular inner wall 48B spaced inwardly from the outer wall 48A, and closer to the axis 11 than the outer wall 48A. A flow transition chamber 49 is defined within the axial portion 44, between the outer and inner walls 48A,48B. The flow transition chamber 49 is an annular cavity within the axial portion 44 of the rotating back plate 40. The flow transition chamber 49 is in fluid communication with the transfer chamber 35 to receive from the nozzles 33 the cooling air, and to transition the cooling air from flowing along an incoming radial direction to leave the flow transition chamber 49 along an outgoing axial direction into the radial passage 42. In the depicted embodiment, the flow transition chamber 49 is circumferentially uninterrupted by other structures of the axial portion 44 along most of the axial length of the flow transition chamber 49.

Still referring to FIGS. 2 and 3, the flow transition chamber 49 has a radial segment 43A which is oriented in a direction being transverse to the axis 11, and an axial segment 43B downstream of the radial segment 43A which is oriented in a direction being substantially parallel to the axis 11. The radial and axial segments 43A,43B allow the cooling air to transition from its incoming radial direction to leave the flow transition chamber 49 along the outgoing axial direction. The radial segment 43A extends radially inwardly from an annular inlet opening 41A defined in the outer wall 48A of the axial portion 44 to form a radial inlet for the flow transition chamber 49. The inlet opening 41A is an open and uniform circumferential space that is in fluid communication with the transfer chamber 35 and helps to reduce or prevent impingement of the cooling air on surfaces of the back plate 40. The axial segment 43B extends axially aft from the radial segment 43A to receive the cooling air therefrom. The axial segment 43B extends through the body of the axial portion 44 of the back plate 40, and extends along a direction parallel to the axis 11 from the radial segment 43A to an annular outlet opening 41B. The outlet opening 41B forms an axially-oriented outlet of the flow transition chamber 49, and is spaced axially aft or downstream of the radial segment 43A. The outlet opening 41B is positioned, shaped, and sized to deliver the cooling air to the radial passage 42 and ultimately to the rotor assembly 18B.

In the embodiment shown in FIGS. 2 and 3, the annular radial segment 43A of the flow transition chamber 49 is defined and delimited by a first radial wall 45A extending in a direction and extent that is transverse to the axis 11, having an orientation extending radially inwardly toward the axis 11 from the outer wall 48A, and a second radial wall 45B spaced axially apart aft or downstream from the first radial wall 45A in a direction toward the outlet opening 41B. The second radial wall 45B also extends radially inwardly from the outer wall 48A.

The annular axial segment 43B of the flow transition chamber 49 is defined and delimited by a first axial wall 47A and a second axial wall 47B. The first axial wall 47A extends in an axial direction and extent, is spaced radially inwardly from the outer wall 48A, and extends from the radial segment 43A to the outlet opening 41B. A radially outer ring 50A of the axial portion 44 of the back plate 40 is defined between the outer wall 48A and the first axial wall 47A. The second axial wall 47B is also spaced radially inwardly from the outer wall 48A, and spaced radially outwardly from the inner wall 48B. The second axial wall 47B is spaced radially inwardly from the first axial wall 47A, and also extends from the radial segment 43A to the outlet opening 41B. A radially inner ring 50B of the axial portion 44 of the back plate 40 is defined between the inner wall 48B and the second axial wall 47B. The outer and inner rings 50A,50B of the axial portion 44 delimit the flow transition chamber 49.

In the embodiment shown in FIGS. 2 and 3, the first radial wall 45A includes a curved segment 45C. Some or all of first radial wall 45A is thus curved to help transition the flow of cooling air from the incoming radial direction to leave the radial segment 43A along an axial direction. The curved segment 45C is flush with the second axial wall 47B. The flow transition chamber 49 therefore has a curved transition surface between the radial and axial segments 43A,43B at an upstream end of the flow transition chamber 49.

In FIGS. 2 and 3, the second radial wall 45B is apertured to fluidly communicate the cooling air from the radial segment 43A to the axial segment 43B of the flow transition chamber 49. The second radial wall 45B includes multiple openings 51 which extend through the second radial wall 45B and which are circumferentially spaced apart about the axis 11. The openings 51 form an inlet of the annular axial segment 43B for the intake of the cooling air that flows through the radial segment 43A of the flow transition chamber 49. The openings 51 form slots or apertures in the second radial wall 45B which each have a radial extent and an axial extent. The openings 51 are oriented along an axial direction, such that the cooling air flows through the openings 51 in a substantially axial direction into the axial segment 43B. The openings 51 conform to a natural tendency of flow of the cooling air to move in an axially helical path. The rotation of the back plate 40 may cause the openings 51 to impart a helical movement or flow vector (i.e. circumferential) to the cooling air flowing through the openings 51. The openings 51 and the orientation of the axial segment 43B may also help to remove the radial flow vector from the flow of cooling air, and impart an axial flow vector being parallel to the axis 11. In the depicted embodiment, each of the openings 51 extends along an opening axis. The opening axes are obtuse or non-parallel to the axis 11, such that each of the openings 51 is slanted.

The portions of the second radial wall 45B between the openings 51 form radially-extending struts 52 or supports which extend between the outer ring 50A and the inner ring 50B of the axial portion 44. The openings 51 are spaced radially inwardly from the outer wall 48A, and spaced radially outwardly from the inner wall 48B. The openings 51 are thus positioned within the flow transition chamber 49. In the depicted embodiment, the openings are positioned radially inwardly from the first axial wall 47A and radially outwardly from the second axial wall 47B. In the depicted embodiment, the openings 51 are holes in the body of the second radial wall 45B itself, between radially outermost and innermost extremities of the second radial wall 45B.

Referring to FIG. 3, the back plate 40 is an integral body. The back plate 40 is a monolithic body. The back plate 40 is a single piece. The integrality of the back plate 40 may be achieved from the method by which it is manufactured. In FIG. 3, the radial portion 46 and the axial portion 44 are integral with one another. Therefore, both the inner and outer rings 50A,50B are features of a single, continuous axial portion 44, and may therefore be subject to uniform hoop stress. The integrality of the axial portion 44 may allow for designing the radially-extending struts 52 to carry small or no loads. In an alternate embodiment, the back plate 40 is made of two or more separate pieces which are assembled together.

Having described some of the components of the TOBI assembly 20, the flow of cooling air therethrough will now be described in greater detail, with reference being made to the flow arrows of the cooling air shown in FIG. 2. During operation of the gas turbine engine 10, the cooling air enters the annular passageway 38 of the body 32 of the TOBI 30 and is then discharged through the nozzles 33 into the transfer chamber 35. The cooling air collected in the transfer chamber 35 flows along a radial direction into the flow transition chamber 49 of the axial portion 44 of the back plate 40, and flows through the axial portion 44 along the axial segment 43B to exit the flow transition chamber 49 via the outlet opening 41B along a substantially axial direction. The cooling air flows through the outlet opening 41B and into the radial passage 42, where it is directed by the rotating rotor disk 18E to the inlets 18G, and then into the internal passages 18H of the rotor blade root 18F and the rotor blade 18D, through which the cooling air is flowable to cool the rotor blade 18D.

It will be appreciated that the geometry of the back plate 40 disclosed herein allows for effectively extending the transfer chamber 35 into the back plate 40, and thus into the rotating portion of the TOBI assembly 20. The flow transition chamber 49 allows the cooling air to be turned from a radial to an axial direction within the rotating air transfer section of the back plate 40. The open and uniform circumferential space provided by the flow transition chamber 49 may help to allow the flow of cooling air to slow down and turn towards the axial direction with reduced moment of momentum and pressure losses. This in turn may help to reduce the static pressure in the transfer chamber 35, and thus help to reduce leakage of cooling air through the seals 37. This may also help to reduce momentum losses of the cooling air transferring from the static frame of the TOBI 30 onto the rotating frame of the back plate 40.

Other arrangements and configurations of the TOBI assembly 20 are possible and within the scope of the present disclosure. Some other arrangements and configurations of TOBIs are disclosed in U.S. Pat. No. 6,183,193; US 2017/0198636; US 2017/0292393 A1; and US 2017/0082027 A1, the entire contents of each of which are incorporated by reference herein.

Referring to FIGS. 2 and 3, there is also disclosed a method for providing cooling air to the rotor assembly 18B. The method includes conveying the cooling air, as a result of it being pressurized during operation of the gas turbine engine 10, through the TOBI 30 to discharge the cooling air from the nozzles 33. The method also includes conveying the cooling air discharged from the nozzles 33 to the back plate 40. This includes including conveying the cooling air in a substantially radial direction toward the axis 11 and into the back plate 40, and then subsequently conveying the cooling air in a substantially axial direction through the back plate 40 to an outlet opening 31B. The method also includes conveying the cooling air from the outlet opening 31B in a substantially radial direction to the rotor assembly 18B. The expression “substantially radial direction” as used herein refers to a directional vector whose radial component is larger than its axial component. In an embodiment, the “substantially radial direction” designates only the radial direction. Similarly, The expression “substantially axial direction” as used herein refers to a directional vector whose axial component is larger than its radial component. In an embodiment, the “substantially axial direction” designates only the axial direction.

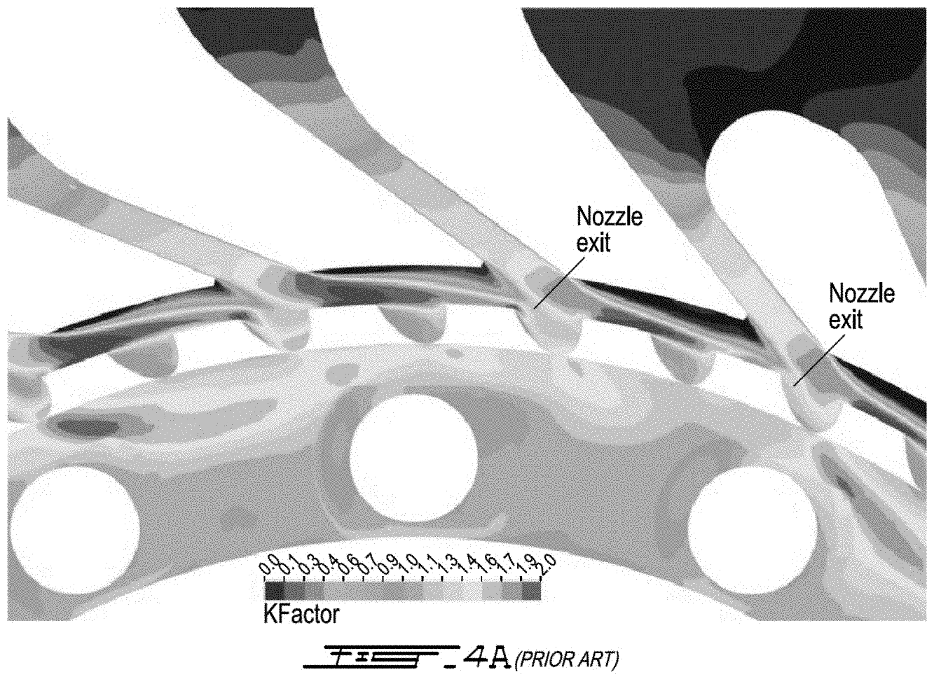

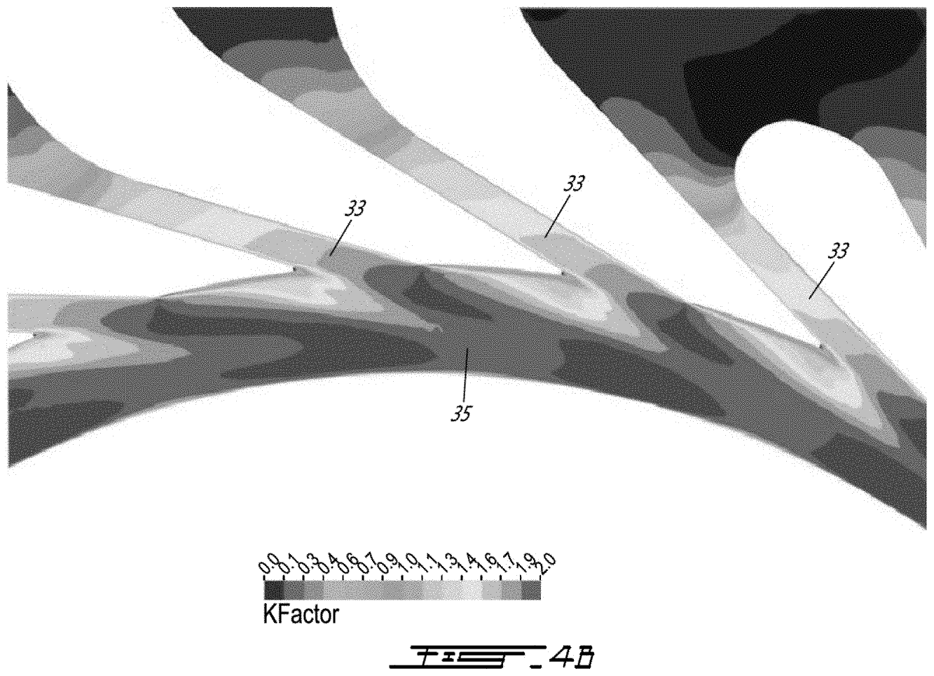

FIG. 4A shows flow patterns due to swirl through the components of a prior art TOBI, and FIG. 4B shows flow patterns due to swirl through the components of the TOBI assembly 20 disclosed herein. FIGS. 4A and 4B show the K factor, which is the ratio between shaft rotational seed of the shaft rotating the back plate 40 and the fluid rotational speed, at various locations. If the K factor is less than 1, then the fluid is rotating slower than the shaft. If the K factor is greater than 1, then the fluid is rotating faster than the shaft. If the K factor is equal to 1, then the fluid is rotating at the same speed as the shaft. It has been observed that a higher K factor at the exit of the nozzles 33 in the transfer chamber 35, results in a lower total temperature of the cooling air at the blade root 18F of the rotor blade 18D. As seen in FIG. 4B, the K factor at the exit of the nozzles 33 in the transfer chamber 35 has a higher value than the K factor at a similar nozzle exit location in the prior art TOBI shown in FIG. 4A. This difference in K factor values suggests that the cooling air provided at the blade root 18F of the rotor blade 18D by the TOBI assembly 20 in FIG. 4B will have a lower total temperature than the cooling air provided by the prior art TOBI shown in FIG. 4A.

The TOBI assembly 20 disclosed herein may, in some embodiments, allow the expansion ratio across the nozzles 33 to be increased to the same level as the turbine stator vanes expansion ratio thus reducing the pressure differential across the seals 37, and helping to reduce leakage losses across the seals 37. The TOBI assembly 20 may help to reduce pressure and speed losses when the cooling air is transferred from the static nozzles 33 to the rotating frame.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A tangential on-board injector (TOBI) assembly of a gas turbine engine, the TOBI assembly comprising:
a TOBI having a body defining an annular passageway configured to receive cooling air, and defining a plurality of discharge nozzles; and
a back plate configured to be mounted for rotation relative to the body about an axis, the back plate having an axial portion spaced radially inwardly from the plurality of discharge nozzles, the axial portion having radially-spaced outer and inner walls defining an annular flow transition chamber, the flow transition chamber having a radial segment extending radially inwardly from an inlet opening communicating with the discharge nozzles, and an axial segment extending axially from the radial segment to an outlet opening configured to deliver the cooling air to a rotor assembly.

2. The TOBI assembly as defined in claim 1, wherein the axial portion includes a first radial wall extending radially inwardly from the outer wall and a second radial wall spaced axially apart from the first radial wall and extending radially inwardly from the outer wall, the first and second radial walls delimiting the radial segment of the flow transition chamber, the second radial wall being apertured to fluidly communicate the cooling air from the radial segment to the axial segment of the flow transition chamber.

3. The TOBI assembly as defined in claim 1, wherein the axial portion includes a first axial wall spaced radially inwardly from the outer wall and extending from the radial segment to the outlet opening, and a second axial wall spaced radially outwardly from the inner wall and radially inwardly from the first axial wall, the second axial wall extending from the radial segment to the outlet opening, the first and second axial walls delimiting the axial segment of the flow transition chamber.

4. The TOBI assembly as defined in claim 2, wherein the first radial wall includes a curved segment.

5. The TOBI assembly as defined in claim 2, wherein the second radial wall includes a plurality of openings circumferentially spaced apart to fluidly communicate the cooling air from the radial segment to the axial segment of the flow transition chamber.

6. The TOBI assembly as defined in claim 5, wherein the plurality of openings in the second radial wall are spaced radially inwardly from the outer wall and radially outwardly from the inner wall.

7. The TOBI assembly as defined in claim 1, wherein the back plate includes a radial portion extending radially outwardly from the axial portion, the radial portion and the axial portion being integral.

8. A method for providing cooling air to a rotor assembly of a gas turbine engine, the method comprising:
conveying the cooling air through a tangential on-board injector (TOBI) to discharge the cooling air from nozzles;
conveying the cooling air discharged from the nozzles of the TOBI to a back plate rotating with the rotor assembly about an axis of rotation, including conveying the cooling air in a substantially radial direction toward the axis and into the back plate, and then conveying the cooling air in a substantially axial direction through the back plate to an outlet opening; and
conveying the cooling air from the outlet opening of the back plate in a substantially radial direction to the rotor assembly.

9. The method as defined in claim 8, further comprising conveying the cooling air through axially-oriented openings in the back plate after conveying the cooling air in the substantially radial direction and before conveying the cooling air in the substantially axial direction.

10. The method as defined in claim 9, wherein conveying the cooling air through the TOBI includes discharging the cooling air from the nozzles to have a swirl flow vector and a radial flow vector.

11. The method as defined in claim 10, wherein conveying the cooling air through axially-oriented openings in the back plate includes substantially removing the radial flow vector and imparting a helical flow vector to the cooling air.

12. The method as defined in claim 8, wherein conveying the cooling air in the substantially radial direction includes conveying the cooling air over a curved surface to transition an orientation of the cooling air from a substantially radial orientation to a substantially axial orientation.

13. The method as defined in claim 8, wherein conveying the cooling air through the TOBI includes maintaining the TOBI stationary.

14. A gas turbine engine, comprising:
a casing assembly;
a rotor assembly rotatable relative to the casing assembly about an axis of the gas turbine engine;
a TOBI having a body fixed to the casing assembly and defining an annular passageway configured to receive cooling air, and defining a plurality of discharge nozzles; and
a back plate mounted to the rotor assembly to rotate therewith about the axis, the back plate having an axially-extending portion spaced radially inwardly from the plurality of discharge nozzles, the axially-extending portion having an outer wall and an inner wall spaced radially inwardly from the outer wall, the axial portion defining an annular flow transition chamber between the outer and inner walls, the flow transition chamber having a radial segment extending radially inwardly from an inlet opening defined in the outer wall and communicating with the plurality of discharge nozzles, and an axial segment extending axially from the radial segment to an outlet opening spaced axially from the radial segment, the outlet opening configured to deliver the cooling air to the rotor assembly.

15. The gas turbine engine as defined in claim 14, wherein the axially-extending portion includes a first radial wall extending radially inwardly from the outer wall and a second radial wall spaced axially apart from the first radial wall and extending radially inwardly from the outer wall, the first and second radial walls delimiting the radial segment of the flow transition chamber, the second radial wall being apertured to fluidly communicate the cooling air from the radial segment to the axial segment of the flow transition chamber.

16. The gas turbine engine as defined in claim 14, wherein the axially-extending portion includes a first axial wall spaced radially inwardly from the outer wall and extending from the radial segment to the outlet opening, and a second axial wall spaced radially outwardly from the inner wall and radially inwardly from the first axial wall, the second axial wall extending from the radial segment to the outlet opening, the first and second axial walls delimiting the axial segment of the flow transition chamber.

17. The gas turbine engine as defined in claim 15, wherein the first radial wall includes a curved segment.

18. The gas turbine engine as defined in claim 15, wherein the second radial wall includes a plurality of openings circumferentially spaced apart to fluidly communicate the cooling air from the radial segment to the axial segment of the flow transition chamber.

19. The gas turbine engine as defined in claim 18, wherein the plurality of openings in the second radial wall are spaced radially inwardly from the outer wall and radially outwardly from the inner wall.

20. The gas turbine engine as defined in claim 14, wherein the back plate includes a radial portion extending radially outwardly from the axial portion, the radial portion and the axial portion being integral.
